(19) United States
(12) Patent Application Publication
(10) Pub. No.: US 2018/0079986 A1
(43) Pub. Date: Mar. 22, 2018

(54) Non-Chlorinated Alkoxylated Alcohol Phosphate for Metal Working

(71) Applicant: Ethox Chemicals, LLC, Greenville, SC (US)

(72) Inventors: Charles F. Palmer, JR., Greenville, SC (US); Ronald E. Bingeman, Greenville, SC (US); William C. Floyd, III, Greenville, SC (US)

(73) Assignee: Ethox Chemicals, LLC

(21) Appl. No.: 15/709,079

(22) Filed: Sep. 19, 2017

Related U.S. Application Data
(60) Provisional application No. 62/396,911, filed on Sep. 20, 2016.

(51) Int. Cl. C10M 137/04; C10M 101/02; C07F 9/09; B21D 37/18

(52) U.S. Cl. CPC C10M 137/04; C10M 101/02; C07F 9/09; C10N 2240/402; C10M 2203/022; C10M 2223/04; C10N 2240/401; B21D 37/18

(57) ABSTRACT

An improved metal working composition is provided. The composition comprises an additive defined by Formula I:

[R¹—(CO)_{y}O(CH₂CHR²O)_{z}]ₙPO₄₋ₙX₃₋ₙ Formula I

wherein:
R¹ is a saturated or unsaturated, branched or linear, alkyl or aryl hydrocarbon group comprising at least 10 to no more than 24 carbons;
each R² is independently selected from H and alkyl of 1-5 carbons;
X is a cation or hydrogen;
y is 0 or 1;
z is an integer of 1 to 20; and
n is 1 or 2.

### CROSS-REFERENCE TO RELATED APPLICATIONS

The present application claims priority to pending U.S. Provisional Appl. No. 62/396,911 filed Sep. 20, 2016, which is incorporated herein by reference

### BACKGROUND

The present invention is related to improved metal working additives. More specifically, the present invention is related to non-chlorinated alkoxylated alcohol phosphates for metal working.

While chlorinated paraffin (CP) has been a highly effective metal working additive, in terms of cost and performance, for nearly a century their continued use is being limited by the U.S. Environmental Protection Agency (EPA). Beginning in 1985, short-chain CPs were listed in the EPA's toxic release inventory. More recently, medium-chain CPs have come under similar scrutiny and their continued use is likely to be banned in the near future.

Although CPs are cost-effective in use, removal of these medium to high viscosity additives is both difficult and expensive. In addition, used fluids containing these chemistries are classified as hazardous wastes under the U.S. Resource Conservation And Recovery Act (RCRA). CPs are classified as persistent in the environment and thus have a high potential for bioaccumulation.

There is a significant demand for metal working additives which do not contain chlorides. Unfortunately, the activity of such materials has been lacking. An improved metal working additive is provided herein.

### SUMMARY OF THE INVENTION

The present invention is related an improved metal working additive.

More specifically, the present invention is related to an improved metal working additive which does not contain chloride and is considered less toxic than prior art additives. Phosphate esters, such as those of the present invention, are known to readily biodegrade.

A particular feature of the invention is the ability for removal and disposal of the metal working additive with water.

Another particular feature of the invention is the suitability of the metal working additive in water-based systems or oil-based systems.

These and other embodiments, as will be realized, are provided in an improved metal working composition comprising an additive defined by Formula I:

[R¹—(CO)_{y}O(CH₂CHR²O)_{z}]ₙPO₄₋ₙX₃₋ₙ Formula I

wherein:
R¹ is a saturated or unsaturated, branched or linear, alkyl or aryl hydrocarbon group comprising at least 10 to no more than 24 carbons;
each R² is independently selected from H and alkyl of 1-5 carbons;
X is a cation or hydrogen;
y is 0 or 1;
z is an integer of 1 to 20; and
n is 1 or 2.

Yet another embodiment is provided in a method of forming a metal working composition comprising:

alkoxylating an alcohol defined as:

R¹OH;

or a carboxylic acid defined as:

R¹COOH;

and terminating the alkoxylated alcohol with phosphate thereby providing a compound of Formula I:

[R¹—(CO)_{y}O(CH₂CHR²O)_{z}]ₙPO₄₋ₙX₃₋ₙ Formula I

wherein:
R¹ is a saturated or unsaturated, branched or linear, alkyl or aryl hydrocarbon group comprising at least 10 to no more than 24 carbons;
each R² is independently selected from H and alkyl of 1-5 carbons;
X is a cation or hydrogen;
y is 0 or 1;
z is an integer of 1 to 20; and
n is 1 or 2.

Yet another embodiment is provided in a method of working metal comprising:

applying a metal working composition to said metal wherein said metal composition comprises an additive defined by Formula I:

[R¹—(CO)_{y}O(CH₂CHR²O)_{z}]ₙPO₄₋ₙX₃₋ₙ Formula I

wherein:
R¹ is a saturated or unsaturated, branched or linear, alkyl or aryl hydrocarbon group comprising at least 10 to no more than 24 carbons;
each R² is independently selected from H and alkyl of 1-5 carbons;
X is a cation or hydrogen;
y is 0 or 1;
z is an integer of 1 to 20; and
n is 1 or 2;
and
stamping, drilling or shaping said metal.

### DESCRIPTION

The present invention is related to an improved additive for metal working. More specifically, the present invention is related to a phosphated, alkoxylated medium-long chain alcohol.

The improved additive is defined by Formula I:

[R¹—(CO)_{y}O(CH₂CHR²O)_{z}]ₙPO₄₋ₙX₃₋ₙ Formula I

wherein:
R¹ is a saturated or unsaturated, branched or linear, alkyl or aryl hydrocarbon group comprising at least 10 to no more than 24 carbons;
each R² is independently selected from H and alkyl of 1-5 carbons;
X is a cation or hydrogen;
y is 0 or 1;
z is an integer of 1 to 20; and
n is 1 or 2.

The improved additive is formed by alkoxylating an alcohol, defined as R¹OH, or carboxylic acid, defined as R¹COOH, followed by formation of the terminal phosphate. Alkoxylation is well known to those of skill in the art and further discussion of the reaction conditions to alkoxylate an alcohol or carboxylic acid is not necessary. In Formula I, subscript y being 0 is achieved by alkoxylation of an alcohol and subscript y being 1 is achieved by alkoxylation of a carboxylic acid. It is known in the art that alkoxylation provides a statistical average distribution as opposed to an equal distribution of alkoxy groups on each molecule. Therefore, a representation of the number of alkoxy groups is understood to be the average with a statistical distribution of molecules having more or less alkoxy groups.

Formation of a terminal phosphate after alkoxylation is well known to those of skill in the art and further elaboration of the reaction is not necessary. Formation of the terminal phosphate can be accomplished by reacting with a phosphating agent, such as polyphosphoric acid or by phosphoric pentoxide, under elevated temperature. The formation of the terminal phosphate is known to provide some small fraction of byproducts such as the presence of molecules with two alkoxylated alcohol moieties per phosphoric acid reactant. In an embodiment of the invention, a polyphosphate such as polyphos 115% is used for the phosphation step. This reaction will yield predominantly monosubstituted phosphate products (n=1), with minor amounts of di-substituted phosphate compounds (n=2) as well as some residual phosphoric acid. If phosphoric pentoxide is used, higher yields of the di- and trisubstituted phosphates will be obtained. While these more highly substituted phosphates are a part of this invention, it has been found that in most cases improved results are obtained from monosubstituted phosphate compounds.

Preferably, R¹ is an alkyl or alkene group. Particularly preferred R¹ are those organic residues of oleyl alcohol, oleic acid, stearic acid, stearyl alcohol, coconut fatty acids, styrenated phenols, or tall oil fatty acids. R¹ can be linear or branched with linear being preferred and oleyl being particularly preferred.

R² is preferably either —H or —CH₃. Preferably, each R² is mixture —H and —CH₃. In another preferred embodiment at least one R² is —CH₃. In a particularly preferred embodiment up to ten R² groups are —CH₃ and more preferably 3-7 R² groups are —CH₃. In another preferred embodiment no more than 10 R² groups are —H and more preferably 1-3 R² groups are —H. Similar R² groups can be arranged in blocks or arranged randomly. For example, with a mixture or —H and —CH₃ groups as R² the —H groups may be in a block and the —CH₃ groups may be in a block as represented by the moiety:

—(CH₂CH₂O)ₐ(CH₂CHCH₃O)_{b}—

wherein the sum of a and b taken together represent integer z. The alkoxylate chains can be obtained by reacting a suitable alcohol or acid with ethylene oxide or propylene oxide. These oxides can be added in a stepwise fashion in order to obtain blocked alkoxylates, or they can be pre-mixed to provide a statistical mixture.

The number of alkoxy groups, represented by integer z, is more preferably at least 4 to no more than 14.

The cation, represented by X, is preferably a cation of a material selected from the group consisting of hydrogen which is a non-neutralized phosphate, sodium, potassium, ammonium, calcium, magnesium, lithium and an amine. Particularly preferred is a hydrogen cation or non-neutralized phosphate. Particularly preferred are cations of aromatic or alkyl amines and alkanol amines with ethanolamine and ethylene amine being particularly preferred.

The improved additive is preferably used in a composition for metal working comprising a base oil. Particularly preferred base oils include mineral oils, vegetable oils and synthetic oils. The improved additive preferably represents about 1 wt % to about 20 wt % with the balance being base oil and additional additives as known in the art. It is preferable that the composition for metal working comprise about 80 wt % to about 99 wt % base oil.

The improved additive has a non-tacky, easy to use, medium viscosity. It is soluble in a wide range of base fluids, including mineral and vegetable oils and esters. It is also compatible with other extreme pressure and lubricity additives, such as esters, sulfurized fats and sulfurized hydrocarbons.

The acid functionality of this invention allows ease of removal using alkaline cleaners. Simple neutralization of this acid with common mineral and organic bases also allow its use in emulsifiable, water-extendable metalworking formulations.

The effect that mixed alkoxylation has on 4-Ball wear performance as compared to purely ethoxylated analogs provides a surprising advantage. While formulations using only ethylene oxide in Formula I are suitable for metal working applications, propylene oxide incorporation provides improved properties. Furthermore, unsaturation in the alcohol chain provides a performance benefit, which is contrary to expectations for lubrication applications. Likewise, the strong 4-ball wear performance of an additive having low-to-medium viscosity is contrary to expectations in the art. The improved additive is particularly suitable for use in combination with other lubricant additives and film strength improvers such as higher viscosity esters, fats, and/or hydrocarbons, extends the use for heavy-duty metal forming applications.

The inventive additive is suitable for use with any metal. The inventive additive is particularly suitable for use in the stamping, drilling and shaping of ferrous and non-ferrous metal. The inventive additive is particularly suitable for use in aluminum, copper, magnesium iron, steel and ferrous alloy.

### EXAMPLES

### Example 1

Oleyl alcohol was reacted with five molar equivalents of propylene oxide, followed by reaction with one and a half moles of ethylene oxide to yield a propoxylated and ethoxylated alcohol. This material was then reacted with 0.33 molar equivalents of PPA 115 polyphosphoric acid to yield Compound 1.

### Example 2

Compound 1 was subjected to a 4-ball wear test according to ASTM D2783-03. Compound 1 was mixed with a paraffinic oil having a Saybolt Universal Second (SUS) viscosity of 100 at 10% by weight and compared to a medium chain chlorinated paraffin also used at 10% by weight. The load wear index and weld load for the medium chain chlorinated paraffin were 41 kgf and 200 kg, respectively, as reported in Table 1. The load wear index and weld load for Compound 1 were above 216 kgf and above 620 kg, respectively as reported in Table 1. This compared favorably to a commercially available chlorinated paraffin replacement with 2.6 wt % phosphorous added.

### Example 3

The procedure for Example 1 was repeated using 5% Compound 1 in paraffinic oil and tested against 5% chlorinated paraffin in paraffin oil. The load wear index and weld load for the medium chain chlorinated paraffin were 57 kgf and 315 kg, respectively. The load wear index and weld load for compound 1 were 77 kgf and above 380 kg, respectively.

### Example 4

To evaluate the impact of structural variations, the above tests were carried out on a version of this material prepared from P₂O₅ rather than polyphosphoric acid (Compound 2), using saturated stearyl alcohol in place of oleyl alcohol (Compound 3), and using five moles of ethylene oxide in place of an ethylene oxide/propylene oxide mixture (Compound 4). Compounds 2-4 were also shown to be superior to chlorinated paraffins as presented in Table 1.

TABLE 1

| 10% loading in 100 SUS | | |
|---|---|---|
| paraffinic oil | Load Wear Index (kgf) | Weld Load (kg) |
| Medium chain chlorinated | 41 | 200 |
| paraffin | | |
| Commercial benchmark | 219 | >620 |
| Compound 1 | >216 | >620 |
| Compound 2 | 80 | 315 |
| Compound 3 | 97 | 315 |
| Compound 4 | 157 | >620 |

The invention has been described with reference to the preferred embodiments without limit thereto. Additional embodiments and improvements may be realized which are not specifically set forth herein but which are within the scope of the invention as more specifically set forth in the claims appended hereto.

1. An improved metal working composition comprising an additive defined by Formula I:
[R¹—(CO)_{y}O(CH₂CHR²O)_{z}]ₙPO₄₋ₙX₃₋ₙ Formula I
wherein:
R¹ is a saturated or unsaturated, branched or linear, alkyl or aryl hydrocarbon group comprising at least 10 to no more than 24 carbons;
each R² is independently selected from H and alkyl of 1-5 carbons;
X is a cation or hydrogen;
y is 0 or 1;
z is an integer of 1 to 20; and
n is 1 or 2.

2. The improved metal working composition of claim 1 wherein said R¹ is selected from the group consisting of an alkyl group and an alkylene group.

3. The improved metal working composition of claim 2 wherein said R¹ is linear or branched.

4. The improved metal working composition of claim 3 wherein said R¹ is selected from the group consisting of oleyl alcohol; oleic acid, stearic acid, styrenated phenols, coconut fatty acids or tall fatty acids.

5. The improved metal working composition of claim 1 wherein each said R² is independently select from the group consisting of —H and —CH₃.

6. The improved metal working composition of claim 5 wherein no more than ten R² groups are —CH₃.

7. The improved metal working composition of claim 6 wherein 3-7 R² groups are —CH₃.

8. The improved metal working composition of claim 5 wherein no more than ten R² groups are —H.

9. The improved metal working composition of claim 8 wherein 1-3 R² groups are —CH₃.

10. The improved metal working composition of claim 1 wherein said z is at least 4 to no more than 14.

11. The improved metal working composition of claim 1 wherein said X is a cation of a material selected from the group consisting of hydrogen, sodium, potassium, ammonia, calcium, magnesium, lithium and an amine.

12. The improved metal working composition of claim 11 wherein said X is a hydrogen cation.

13. The improved metal working composition of claim 11 wherein said X is a cation of an aromatic amine or an alkyl amine.

14. The improved metal working composition of claim 13 wherein said X is a cation of ethanolamine or ethylene amine.

15. The improved metal working composition of claim 1 wherein said y is zero.

16. The improved metal working composition of claim 1 further comprising a mineral oil, a vegetable oil, or a synthetic oil.

17. The improved metal working composition of claim 16 comprising at least 1 wt % to no more than 20 wt % of said Formula I.

18. A method of forming a metal working composition comprising:
alkoxylating an alcohol defined as:
R¹OH;
or a carboxylic acid defined as:
R¹COOH;
and terminating the alkoxylated alcohol with phosphate thereby providing a compound of Formula I:
[R¹—(CO)_{y}O(CH₂CHR²O)_{z}]ₙPO₄₋ₙX₃₋ₙ Formula I
wherein:
R¹ is a saturated or unsaturated, branched or linear, alkyl or aryl hydrocarbon group comprising at least 10 to no more than 24 carbons;
each R² is independently selected from H and alkyl of 1-5 carbons;
X is a cation or hydrogen;
y is 0 or 1;
z is an integer of 1 to 20; and
n is 1 or 2.

19. The method of forming a metal working composition of claim 18 wherein said R¹ is selected from the group consisting of an alkyl group and an alkylene group.

20. The method of forming a metal working composition of claim 19 wherein said R¹ is linear or branched.

21. The method of forming a metal working composition of claim 20 wherein said R¹ is selected from the group consisting of oleyl alcohol; oleic acid, stearic acid, styrenated phenols, coconut fatty acids or tall oil fatty acids.

22. The method of forming a metal working composition of claim 18 wherein each said R² is independently selected from the group consisting of —H and —CH₃.

23. The method of forming a metal working composition of claim 22 wherein no more than ten R² groups are —CH₃.

24. The method of forming a metal working composition of claim 23 wherein 3-7 R² groups are —CH₃.

25. The method of forming a metal working composition of claim 22 wherein no more than ten R² groups are —H.

26. The method of forming a metal working composition of claim 25 wherein 1-3 R² groups are —CH₃.

27. The method of forming a metal working composition of claim 18 wherein said z is at least 4 to no more than 14.

28. The method of forming a metal working composition of claim 18 wherein said X is a cation of a material selected from the group consisting of hydrogen, sodium, potassium, ammonia, calcium, magnesium, lithium and an amine.

29. The method of forming a metal working composition of claim 28 wherein said X is a hydrogen cation.

30. The method of forming a metal working composition of claim 28 wherein said X is a cation of an aromatic amine or an alkyl amine.

31. The method of forming a metal working composition of claim 30 wherein said X is a cation of ethanolamine or ethylene amine.

32. The method of forming a metal working composition of claim 18 wherein said y is zero.

33. The method of forming a metal working composition of claim 18 further comprising a mineral oil, a vegetable oil, or a synthetic oil.

34. The method of forming a metal working composition of claim 33 comprising at least 1 wt % to no more than 20 wt % of said Formula I.

35. The method of forming a metal working composition of claim 18 where said terminating comprises reacting with phosphating agent selected from the group consisting of polyphosphoric acid and an oligomeric form of phosphoric acid.

36. A method of working metal comprising:
applying a metal working composition to said metal wherein said metal composition comprises an additive defined by Formula I:
[R¹—(CO)_{y}O(CH₂CHR²O)_{z}]ₙPO₄₋ₙX₃₋ₙ Formula I
wherein:
R¹ is a saturated or unsaturated, branched or linear, alkyl or aryl hydrocarbon group comprising at least 10 to no more than 24 carbons;
each R² is independently selected from H and alkyl of 1-5 carbons;
X is a cation or hydrogen;
y is 0 or 1;
z is an integer of 1 to 20; and
n is 1 or 2;
and
stamping, drilling or shaping said metal.

37. The method of working metal of claim 36 wherein said metal is selected from the group consisting of aluminum, copper, magnesium, iron, steel, or a ferrous alloy.

38. The method of working metal of claim 36 wherein said R¹ is selected from the group consisting of an alkyl group and an alkylene group.

39. The method of working metal of claim 38 wherein said R¹ is linear or branched.

40. The method of working metal of claim 39 wherein said R¹ is selected from the group consisting of oleyl alcohol; oleic acid, stearic acid, styrenated phenols, coconut fatty acids or tall oil fatty acids.

41. The method of working metal of claim 36 wherein each said R² is independently select from the group consisting of —H and —CH₃.

42. The method of working metal of claim 41 wherein no more than ten R² groups are —CH₃.

43. The method of working metal of claim 42 wherein 3-7 R² groups are —CH₃.

44. The method of working metal of claim 41 wherein no more than ten R² groups are —H.

45. The method of working metal of claim 44 wherein 1-3 R² groups are —CH₃.

46. The method of working metal of claim 36 wherein said z is at least 4 to no more than 14.

47. The method of working metal of claim 36 wherein said X is a cation of a material selected from the group consisting of hydrogen, sodium, potassium, ammonia, calcium, magnesium, lithium and an amine.

48. The method of working metal of claim 47 wherein said X is a hydrogen cation.

49. The method of working metal of claim 47 wherein said X is a cation of an aromatic amine or an alkyl amine.

50. The method of working metal of claim 49 wherein said X is a cation of ethanolamine or ethylene amine.

51. The method of working metal of claim 36 wherein said y is zero.

52. The method of working metal of claim 36 further comprising a mineral oil, a vegetable oil, or a synthetic oil.

53. The method of working metal of claim 52 where comprising at least 1 wt % to no more than 20 wt % of said Formula I.
